(19) United States
(12) Patent Application Publication
(10) Pub. No.: US 2016/0282491 A1
(43) Pub. Date: Sep. 29, 2016

(54) PREDICTIVE VIBRATION MODELS UNDER RISERLESS CONDITION

(71) Applicant: LANDMARK GRAPHICS CORPORATION, Houston, TX (US)

(72) Inventors: Robello Samuel, Cypress, TX (US); Gustavo Adolfo Urdaneta, Houston, TX (US)

(73) Assignee: Landmark Graphics Corporation, Houston, TX (US)

(21) Appl. No.: 14/442,667

(22) PCT Filed: Nov. 18, 2013
(86) PCT No.: PCT/US2013/070552

§ 371 Date: May 13, 2015

(51) Int. Cl. G01V 1/38; E21B 47/04; G01V 1/30; G01V 1/28; G01V 1/40; E21B 7/12; E21B 47/00

(52) U.S. Cl. CPC G01V 1/3808; E21B 7/12; E21B 47/04; E21B 47/0006; G01V 1/282; G01V 1/40; G01V 1/306

(57) ABSTRACT

Systems and methods provide a mechanism to provide enhanced features for riserless drilling. Various embodiments may include wellbore analysis to predict and quantify vibrations for riserless conditions. Additional apparatus, systems, and methods are disclosed.

### TECHNICAL FIELD

The present invention relates generally to apparatus and methods related to measurements and analysis of drilling and production structures.

### BACKGROUND

Riserless drilling poses numerous operational challenges, which are manifested in a number of ways, all adversely affecting the efficiency of the drilling process. The problems include increased torque and drag, increased vibration, poor hole-cleaning, tubular failures, poor cement jobs, and associated problems during tripping operations. Drilling in deepwater and ultra-deepwater, as well as extending the reach to a greater depth in the riserless environment, requires both improved models and comprehensive analysis especially when the bigger diameter casing pipes are run and cemented.

### BRIEF DESCRIPTION OF THE DRAWINGS

FIG. 1 shows a model of a section to determine side forces, moments, and forces at the ends of the section, in accordance with various embodiments.

FIG. 2 shows different scenarios of drilling operations, in accordance with various embodiments.

FIG. 3 shows features of an example process flow to analyze a riserless structure, in accordance with various embodiments.

FIG. 4 illustrates features of an example method to analyze a riserless structure, in accordance with various embodiments.

FIG. 5 depicts a block diagram of features of an example system operable to control a predictive vibration model under riserless condition, in accordance with various embodiments.

### DETAILED DESCRIPTION

The following detailed description refers to the accompanying drawings that show, by way of illustration and not limitation, various embodiments in which the invention may be practiced. These embodiments are described in sufficient detail to enable those skilled in the art to practice these and other embodiments. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

Calculations without proper modeling can gravely underestimate the hook load values when the casing strings are run in deepwater situation. In various embodiments, a modeling approach uses scenarios for drillstring/casing strings in open water as well as in open hole under different operating conditions to arrive at appropriate hook load values in addition to torque and drag calculations. Both a combination of soft and stiff string models can be used for the tension force estimation as well as the wellhead side loading calculations. For scenarios of casing and inner string run with drilling mud inside the inner string, sea water in the outer string and pad mud in the hole below the mud line, research in accordance with the teachings herein has provided results that present hook load calculations. The study concludes that various parameters influence the results such as offset of the wellhead from the rig center, wellbore inclination, curvature, wellbore torsion, angle of entry into the wellhead besides the complexity due to wind, wave forces as well as ocean loop currents. To explain the rigor of the implementation of the modeling approach, a comparison of the predicted mathematical simulation results to the actual well data from different wells was conducted.

In various embodiments, models can include a number of operations, where the operations can include drilling (rotating on bottom), rotating off bottom, tripping in, tripping out, backreaming, and sliding. Tripping in is placing a drillstring in the borehole and tripping out is pulling the drillstring out of the borehole. Backreaming refers to pulling the drillstring out of the hole, while, at the same time, pumping and rotating the drillstring. Sliding refers to rotating the bit downhole with a mud motor without rotating the drillstring from the surface. The related operational parameters include such parameters as weight on bit, bit or pipe rotation, trip speed, fluid flow, fluid position, acceleration/deceleration of pipe speed, and other parameters.

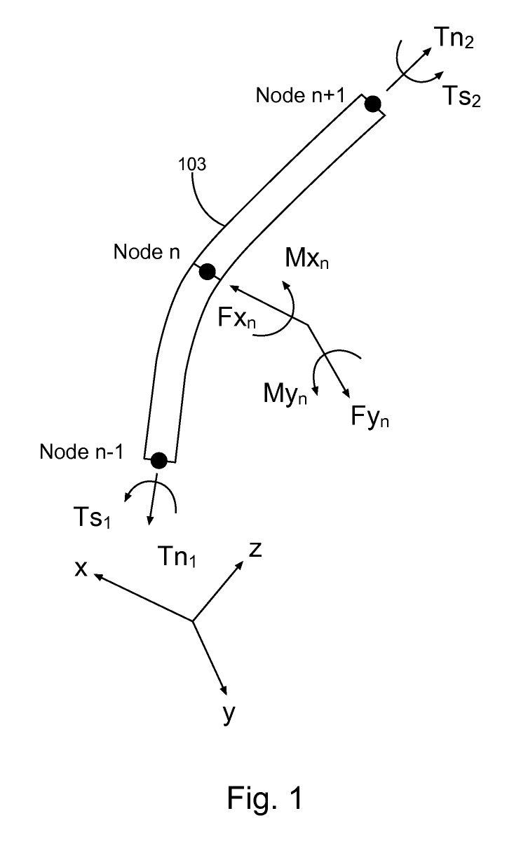

FIG. 1 shows a model of a section 103 to determine side forces, moments, and forces at the ends of the section 103. Section 103 can be considered with respect to three nodes: n−1, n, and n+1, where the complete structure can be considered as a multi-node structure categorized by segments. The node n is taken to be in the vicinity of the bend of section 103 at which there are side forces Fxₙ and Fx_{y} and moments Mxₙ and Mx_{y} for the coordinates shown. Nodes n−1 and n+1 are taken to be at the respective ends of segment 103. At node n−1, there is an axial force, Tn₁, and a shear force, Ts₁, and at node n+1, there is an axial force, Tn₂, and a shear force, Ts₂. The model shown in FIG. 1 can be used to analyze riserless structures. Different scenarios that can be addressed include, but are not limited to single pipe as well as pipe in pipe, coiled tubing pipe, casing liner, and other arrangements.

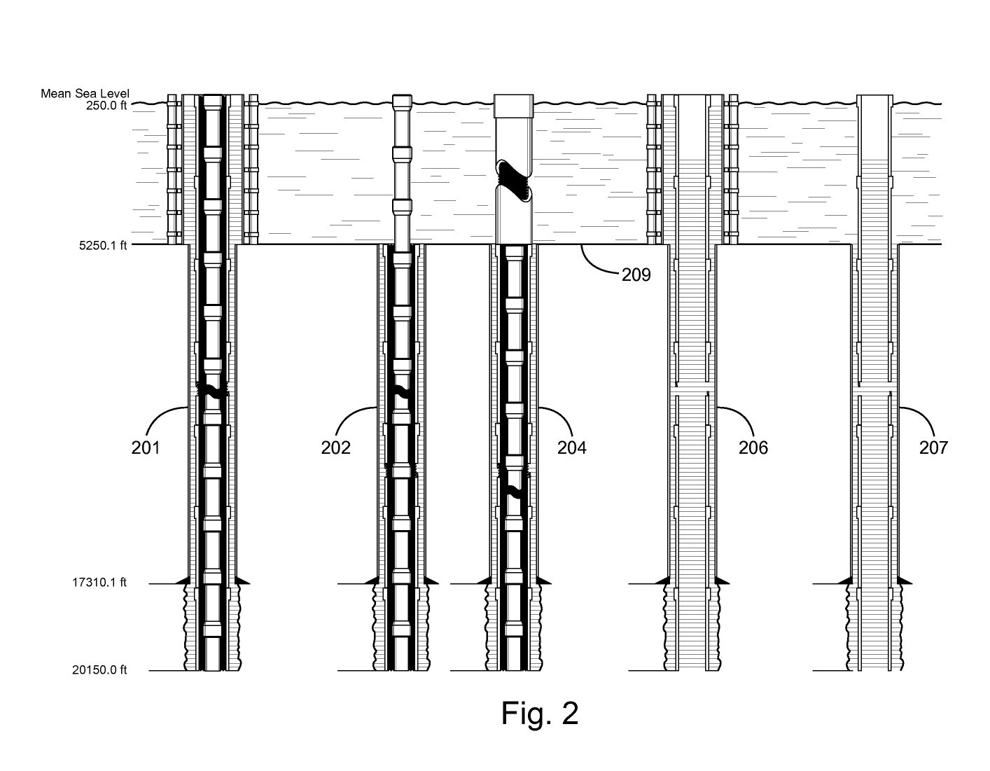

FIG. 2 shows different scenarios 201, 202, 204, 206, and 207. Scenarios 201 and 206 are structures for which traditional analysis has been performed. Scenario 204 shows a pipe within a pipe. Scenarios 202 and 207 show structures extending from the mud line 209 through water in a riserless condition. In various embodiments, wellbore analysis is used to predict and quantify vibrations for riserless conditions such as, but not limited to, scenarios 202 and 207. The various analysis applied to riserless conditions discussed herein provide enhancements to capabilities to design and operate such riserless structures.

Different models can be used to calculate the side force at the wellhead. These models can include a soft string model, a stiff string model that can include the stiffness of the pipe, and a finite element method. The local stiffness matrix is important to analysis, as it represents how rigid or bendable is the drillstring or casing string. The relationship between the stiffness matrix and the nodal forces, displacements, rotation, and moments is defined in equation (1) as

{F}=[K]{δ} (1)

where
{F}=vector of nodal loads and moments
[K]=stiffness matrix
{δ}=vector of nodal displacements and rotations
   Matrices of stiffness coefficients for individual finite elements are combined to formulate the mathematical relations for external force acting at any node. The stiffness matrix [K] is composed of the following
E=Young's Modulus (lb/in²)
I=Moment of Inertia (in⁴)
G=Modulus of Rigidity E/2(1+γ)
J=Polar Moment of Inertia
γ=Poisson's Ratio

Calculation of riser length can be based on catenary profile. Other profiles and related calculations can be included. The length of catenary section can be calculated by:

ΔL=(ω/F_{H}){sin h[(L−C₂)(ω/F_{H})]−C₂} (2)

where
L=offset distance, ft
a=(F_{H}/ω)
C₂=−a sin h⁻¹ (tan θ)
   In another form, the mud line depth can be given as

D_{ω}=(F_{H}/L)cos h(L−C₂)(ω/F_{H})+C₃ (3)

where
C=−a cos h K′ with K′=sin h⁻¹ (tan θ)
ω=average weight per length of the riser.
   If multiple weights of the string are run, then the average weight of the string per unit length is used. Equation (3) can be used iteratively to solve L to obtain the side force at the wellhead.

With respect to hook load calculations, according to the Coulomb friction model, the axial force at the end of the catenary section that is required to pull the drillstring along the sail section is given by:

F_{c}=F_{S}+W(cos α_{c}±μ sin α_{c} (4)

The axial force, F_{S}, depends on the side force at the wellhead. The plus sign defines tripping out operation, whereas the minus sign defines tripping in operation.

Another important parameter to be considered is the wellbore quality as well as the wellbore tortuosity. The ability to quantify complex wellbore trajectories with good accuracy can provide reliable guidance to estimate risk involved. Previously published papers describe the quality of the hole more subjectively rather than quantifying the hole qualitatively. Furthermore, there is no clear criterion for defining the quality of the wellbore. Wellbore Score card (WCS) used to gauge the quality of the hole is also more subjective in nature rather than quantifying the hole qualitatively. During the planning stage, the estimation is grossly subjective as it will be made with uncertainty and variability of the operations. The estimation also has to be based on the previous drilled offset wells and may be applicable only to the area where the well is being planned. The wellbore quality score card has resulted in a good wellbore quality, but difficulties in casing running were encountered in the riserless condition. The parameter that is being neglected in the survey calculations is wellbore torsion, which depicts the rotating rate of the binormal vector with respect to curved length, or the measure of the rate at which the osculating plane changes its direction. It not only ensures a smooth well path but also reduces the drag and torque. In addition, the wellbore torsion emphasizes the undulation of the wellpath curvature of the sharp wellpaths to a greater extent than obtained from previous methods.

The wellbore energy, E_{S}, can be made more comprehensive for the wellpath design with the inclusion of the torsion parameter as the arc length integral of the torsion squared. The wellbore energy can be given as:

$${E}_{s} = {\int }_{0}^{𝓁} ( {κ ( x )}^{2} + {τ ( x )}^{2} ) d x \qquad ( 5 )$$

where κ is the curvature and ti is the wellbore torsion. The wellbore energy can be further normalized to a standard wellbore course length between survey stations, where the normalized wellbore energy can be given as

$${E}_{{( ab s )}_{n}} = ( \frac{{\sum }_{i = 1}^{n} ( {κ}_{i}^{2} + {τ}_{i}^{2} ) Δ {D}_{i}}{{D}_{n} + Δ {D}_{n}} ) . \qquad ( 6 )$$

where i corresponds to the i^{th} survey station, n is a depth point, D is depth, Dₙ is the depth at the n^{th} depth point, ΔDₙ is a depth interval with respect to the n^{th} depth point, and ΔDᵢ is a depth interval with respect to the i^{th} survey station.

Minimization of the total energy of the curve can result in less torque and drag during several of operations. This calculation can be instrumental when the strings are run in a riserless environment.

In traditional evaluation methods, outliers are discarded and are not part of the traditional analysis methods. In various embodiments, methods can include arrangements to analyze the outlier data to find out and predict failures. The outlier data includes noisy data that can be used to compare with predictive data. This noisy data may be associated with regions in which direct measurements are made. A comprehensive methodology, as discussed herein, can use the outlier data for forward prediction and non-productive time estimation.

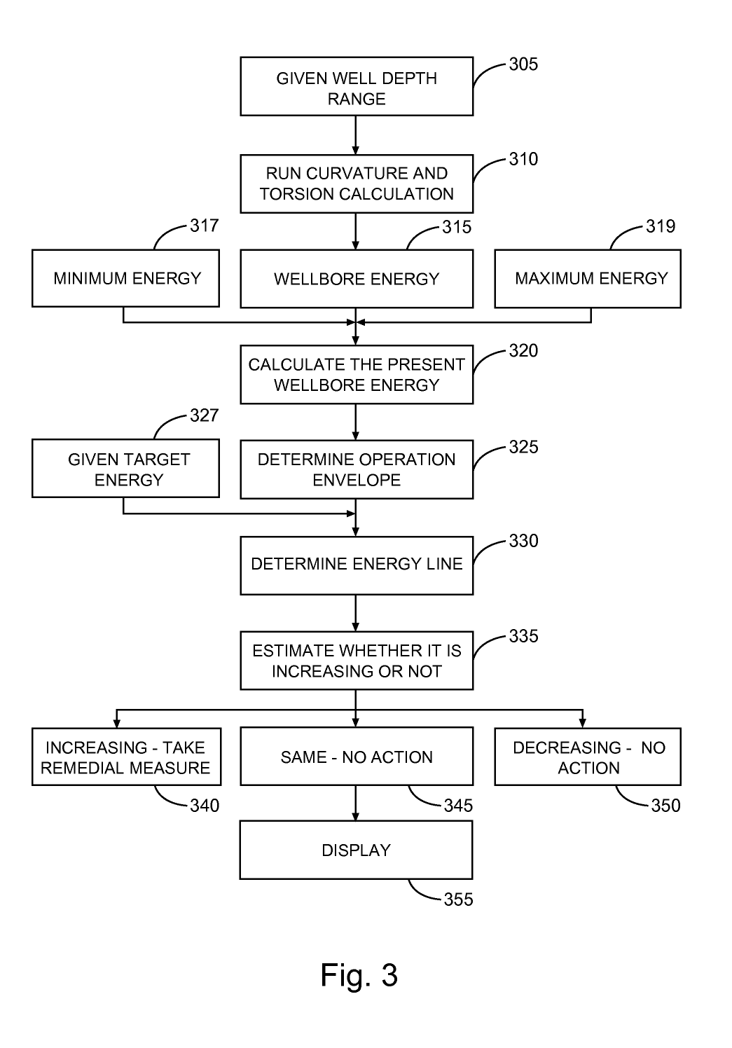

FIG. 3 shows features of an example process flow to analyze a riserless structure. At 305, a well depth range is given. Inputs can include, but are not limited to, well path details and mud line depth. The inputs structure may include torque and drag, swab and surge, and a vibration model. The torque and drag may include, but are not limited to, side force, drag, and torque. The swab and surge may include, but are not limited to, swab, surge, and reciprocation. Swab is related to flow of reservoir in a type of completed well. Data on surges in flow and pressure may be included in the inputs structure. Reciprocation is related to raising and lowering the drillstring. Reciprocation data can include a range of vertical travel. The vibration model may include, but are not limited to, one or more of a lateral model, an axial model, or a torsional model.

At 310, curvature and torsion calculations are run. At 315, wellbore energy analysis is conducted. The wellbore energy analysis can include minimum energy determination, at 317, and a maximum energy analysis, at 319. At 320, the present wellbore energy is calculated. At 325, an operation envelope is determined and a target energy is given at 327. At 330, an energy line is determined in view of the operation envelope and given target energy. At 335, an estimate is conducted as to whether the energy line is increasing or not. At 340, remedial measures can be taken if the energy line is increasing. At 345, no action need be taken if the energy line remains the same compared to previous determination. At 350, no action need be taken if the energy line is decreasing. At 355, the action to be taken, which may include remedial measures or no action, can be displayed on a display device. The above process flow can be applied to, but is not limited to, drillpipe in open waters, casing in open waters, and pipe in pipe scenarios.

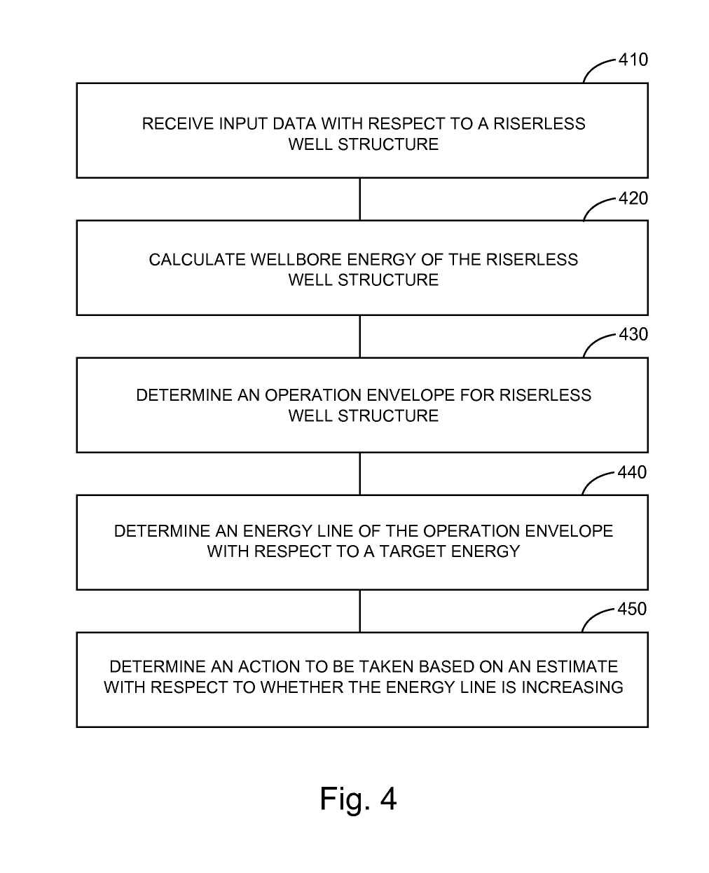

FIG. 4 illustrates features of an embodiment of an example method to analyze a riserless structure. At 410, input data with respect to a riserless well structure is received. The input data can include one or more of well depth range, mud line depth, or survey details. The input data can include torque and drag information, swab and surge information, and a vibration model.

At 420, wellbore energy of the riserless well structure is calculated. At 430, an operation envelope for riserless well structure is determined. At 440, an energy line of the operation envelope determined with respect to a target energy. At 450, an action to be taken is determined based on an estimate with respect to whether the energy line is increasing. Determining an action can include taking a remedial measure if the energy line is increasing and taking no action if the energy line remains the same or is decreasing. The action may be presented on a display device. Data collected and derived during the analysis process can be presented to the display device in addition to the action to be taken.

In various embodiments, the method may include performing curvature and torsion calculation from the input data and determining a minimum energy and a maximum energy as input to calculating the wellbore energy of the riserless well structure. In various embodiments, the method can include analyzing outlier data to find and predict failures. Outlier data is data that is significantly distance from the expected range of values in an experiment such that, in a standard analysis, it may be discarded from the data set of interest. The outlier data can include noisy data that can be used to compare with predictive data. The outlier data can be used to conduct forward prediction and non-productive time estimation.

In various embodiments, a machine-readable storage device can comprise instructions stored thereon, which, when performed by a machine, cause the machine to perform operations, the operations comprising one or more features similar to or identical to features of methods and techniques related to analyze of a riserless condition as described herein. The physical structure of such instructions may be operated on by one or more processors. Executing these physical structures can cause the machine to perform operations to: receive input data with respect to a riserless well structure; calculate wellbore energy of the riserless well structure; determine an operation envelope for riserless well structure; determine an energy line of the operation envelope with respect to a target energy; and determine an action to be taken based on an estimate with respect to whether the energy line is increasing. Further, a machine-readable storage device, herein, is a physical device that stores data represented by physical structure within the device. Examples of machine-readable storage devices can include, but are not limited to, read only memory (ROM), random access memory (RAM), a magnetic disk storage device, an optical storage device, a flash memory, and other electronic, magnetic, and/or optical memory devices.

In various embodiments, a system can comprise: a processor unit and a memory unit operatively coupled to the processor unit such that the processor unit and the memory unit are arranged to perform operations to: receive input data with respect to a riserless well structure; calculate wellbore energy of the riserless well structure; determine an operation envelope for riserless well structure; determine an energy line of the operation envelope with respect to a target energy; and determine an action to be taken based on an estimate with respect to whether the energy line is increasing. The input data can include one or more of well depth range, mud line depth, or survey details. The input data can include torque and drag information, swab and surge information, and a vibration model. The processor unit and the memory unit can be arranged to perform curvature and torsion calculations from the input data and to determine a minimum energy and a maximum energy as input to calculate the wellbore energy of the riserless well structure. The action to be taken can include taking a remedial measure if the energy line is increasing and taking no action if the energy line remains the same or is decreasing. The system can include a display device on which to present the action.

In various embodiments, the processor unit and the memory unit can be arranged to operatively analyze outlier data to find and predict failures. The outlier data can include noisy data that can be used to compare with predictive data. The processor unit and the memory unit can be arranged to operatively to conduct forward prediction and non-productive time estimation using the outlier data.

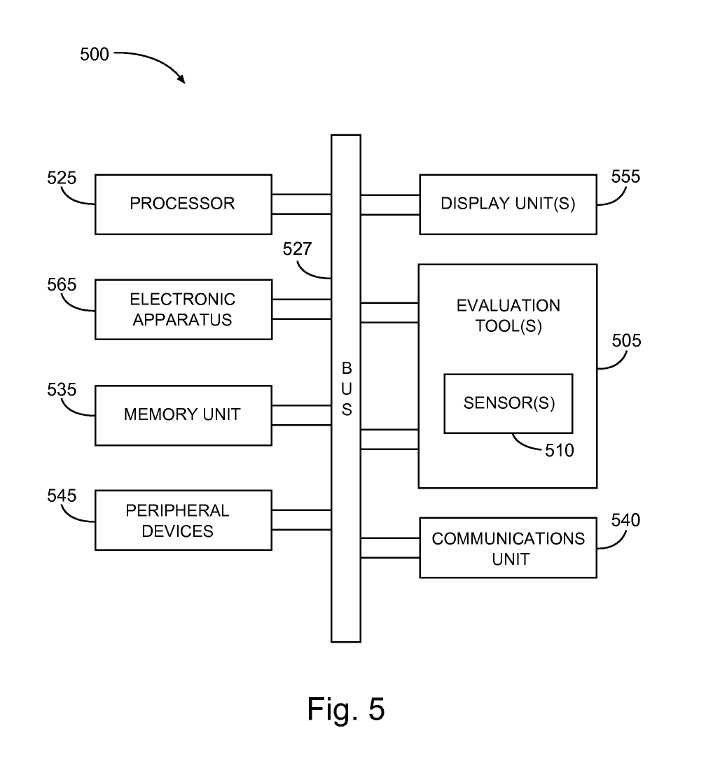

FIG. 5 depicts a block diagram of features of an embodiment of an example system 500 operable to perform analysis of a riserless structure as taught herein. The system 500 can also include a processor unit 525 and a memory unit 535. Memory unit 535 can be realized as one or more machine-readable storage devices having instructions stored thereon, which, when performed by the system 500 in conjunction with processing unit 520, cause the system 500 to perform operations, the operations comprising wellbore analysis to predict and quantify vibrations for riserless conditions as taught herein. The system 500 may include one or more evaluation tools 505 having one or more sensors 510 operable to make measurements with respect to a wellbore. Some of the one or more sensors 510 can be located at the well head. The processor unit 525 and the memory unit 535 can be arranged to operate the one or more evaluation tools 505 to acquire measurement data as the one or more evaluation tools 505 are operated. The processor unit 525 and the memory unit 535 can be realized to control activation and data acquisition of the one or more sensors 510 and to manage processing schemes with respect to data as described herein. The system 500 can also include an electronic apparatus 565 and a communications unit 540.

Electronic apparatus 565 can be used in conjunction with the processor unit 525 to perform tasks associated with taking measurements downhole with the one or more sensors 510 of the one or more evaluation tools 505. The communications unit 540 can include downhole communications in a drilling operation or in a production operation. Such downhole communications can include a telemetry system.

The system 500 can also include a bus 527, where the bus 527 provides electrical conductivity among the components of the system 500. The bus 527 can include an address bus, a data bus, and a control bus, each independently configured. The bus 527 can also use common conductive lines for providing one or more of address, data, or control, the use of which can be regulated by the processor unit 525. The bus 527 can include optical transmission medium to provide optical signals among the various components of system 500. The bus 527 can be configured such that the components of the system 500 are distributed. The bus 527 may include network capabilities.

In various embodiments, peripheral devices 545 can include displays, additional storage memory, and/or other control devices that may operate in conjunction with the processor unit 525 and/or the memory unit 535. In an embodiment, the processor unit 525 can be realized as one or more processors. The peripheral devices 545 can be arranged to operate in conjunction with display unit(s) 555 with instructions stored in the memory unit 535 to implement a user interface to manage the operation of the one or more evaluation tools 505 and/or components distributed within the system 500. Such a user interface can be operated in conjunction with the communications unit 540 and the bus 527. The display unit(s) 555 can be arranged to present actions to be taken resulting from the memory unit 535 in conjunction with processing unit 520 performing wellbore analysis to predict and quantify vibrations for riserless conditions as taught herein.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

What is claimed is:

1. A method comprising:
receiving input data with respect to a riserless well structure;
calculating wellbore energy of the riserless well structure;
determining an operation envelope for riserless well structure;
determining an energy line of the operation envelope with respect to a target energy; and
determining an action to be taken based on an estimate with respect to whether the energy line is increasing.

2. The method of claim 1, wherein the method includes performing curvature and torsion calculation from the input data and determining a minimum energy and a maximum energy as input to calculating the wellbore energy of the riserless well structure.

3. The method of claim 1, wherein determining an action includes taking a remedial measure if the energy line is increasing and taking no action if the energy line remains the same or is decreasing.

4. The method of claim 1, wherein the method includes presenting the action on a display device.

5. The method of claim 1, wherein receiving input data includes one or more of well depth range, mud line depth, or survey details.

6. The method of claim 1, wherein receiving input data includes torque and drag information, swab and surge information, and a vibration model.

7. The method of claim 1, wherein the method includes analyzing outlier data to find and predict failures.

8. The method of claim 7, wherein the outlier data includes noisy data that can be used to compare with predictive data.

9. The method of claim 7, wherein the outlier data is used to conduct forward prediction and non-productive time estimation.

10. A machine-readable storage device having instructions stored thereon, which, when performed by a machine, cause the machine to perform operations, the operations comprising operations to:
receive input data with respect to a riserless well structure;
calculate wellbore energy of the riserless well structure;
determine an operation envelope for riserless well structure;
determine an energy line of the operation envelope with respect to a target energy; and
determine an action to be taken based on an estimate with respect to whether the energy line is increasing.

11. The machine-readable storage device of claim 10, wherein the operations include performing curvature and torsion calculation from the input data and determining a minimum energy and a maximum energy as input to calculating the wellbore energy of the riserless well structure.

12. The machine-readable storage device of claim 10, wherein operations to determine an action include taking a remedial measure if the energy line is increasing and taking no action if the energy line remains the same or is decreasing.

13. The machine-readable storage device of claim 10, wherein the operations include presenting the action on a display device.

14. The machine-readable storage device of claim 10, wherein the input data includes one or more of well depth range, mud line depth, or survey details.

15. The machine-readable storage device of claim 10, wherein the input data includes torque and drag information, swab and surge information, and a vibration model.

16. The machine-readable storage device of claim 10, wherein the operations include analyzing outlier data to find and predict failures.

17. The machine-readable storage device of claim 16, wherein the outlier data includes noisy data that can be used to compare with predictive data.

18. The machine-readable storage device of claim 16, wherein the operations include using the outlier data to conduct forward prediction and non-productive time estimation.

19. A system comprising:
a processor unit; and
a memory unit operatively coupled to the processor unit such that the processor unit and the memory unit are arranged to perform operations to:
receive input data with respect to a riserless well structure;
calculate wellbore energy of the riserless well structure;
determine an operation envelope for riserless well structure;
determine an energy line of the operation envelope with respect to a target energy; and
determine an action to be taken based on an estimate with respect to whether the energy line is increasing.

20. The system of claim 19, wherein the processor unit and the memory unit are arranged to perform curvature and torsion calculations from the input data and to determine a minimum energy and a maximum energy as input to calculate the wellbore energy of the riserless well structure.

21. The system of claim 19, wherein the action includes taking a remedial measure if the energy line is increasing and taking no action if the energy line remains the same or is decreasing.

22. The system of claim 19, wherein the system includes a display device on which to present the action.

23. The system of claim 19, wherein the input data includes one or more of well depth range, mud line depth, or survey details.

24. The system of claim 19, wherein the input data includes torque and drag information, swab and surge information, and a vibration model.

25. The system of claim 19, wherein the processor unit and the memory unit are arranged to operatively analyze outlier data to find and predict failures.

26. The system of claim 25, wherein the outlier data includes noisy data that can be used to compare with predictive data.

27. The system of claim 25, wherein the processor unit and the memory unit are arranged to operatively to conduct forward prediction and non-productive time estimation using the outlier data.
